(19) United States
(12) Patent Application Publication
(10) Pub. No.: US 2020/0055343 A1
(43) Pub. Date: Feb. 20, 2020

(54) Pneumatic vehicle tyre with a belt ply having steel reinforcing elements

(71) Applicant: Continental Reifen Deutschland GmbH, Hannover (DE)

(72) Inventors: Joana Palavras, Hannover (DE); Viktoria Werner, Garbsen (DE); Lubos Novosad, Puchov (SK); Alexandra Randova, Povazska Bystrica (SK)

(73) Assignee: Continental Reifen Deutschland GmbH, Hannover (DE)

(21) Appl. No.: 16/344,814

(22) PCT Filed: Sep. 28, 2017
(86) PCT No.: PCT/EP2017/074574

§ 371 Date: Apr. 25, 2019

(30) Foreign Application Priority Data
Nov. 25, 2016 (DE) 10 2016 223 400.5
Dec. 16, 2016 (DE) 10 2016 225 234.8

(51) Int. Cl. B60C 9/20; B60C 9/00; B60C 9/04

(52) U.S. Cl. CPC B60C 9/2006; B60C 9/04; B60C 9/0007

(57) ABSTRACT

Pneumatic vehicle tire having two or more belt plies which have reinforcement members crossing one another at an angle, wherein the reinforcement members within each belt ply are arranged substantially parallel to and spaced apart from one another and are embedded in rubber material, wherein the belt has at least one first belt ply, the reinforcement members of which are formed by steel cords composed of two twisted-together steel monofilaments, wherein the steel falls within the reinforcement member class Ultra-Tensile (UT) with in each case a tensile strength of 3185 N/mm² to 3920 N/mm². It is therefore the object of the invention to provide a pneumatic vehicle tyre with low rolling resistance and simultaneously good handling properties. The object is achieved in that the first belt ply, at a predefined elongation of 1% in the direction of the reinforcement member longitudinal extent, has a stress of 26000 N per dm width to 43000 N per dm width.

The invention relates to a pneumatic vehicle tire having two or more belt plies which have reinforcement members crossing one another at an angle, wherein the reinforcement members within each belt ply are arranged substantially parallel to and spaced apart from one another and are embedded in rubber material, wherein the belt has at least one first belt ply, the reinforcement members of which are formed by steel cords composed of two twisted-together steel monofilaments, wherein the steel falls within the reinforcement member class Ultra-Tensile (UT) with in each case a tensile strength of 3185 N/mm² to 3920 N/mm².

A pneumatic vehicle tire of radial type of construction generally has an inner layer which is impermeable to air, a radial carcass comprising reinforcement members, which carcass extends from the zenith region of the tire via the side walls into the bead region and is normally anchored there by being looped around tension-resistant bead cores, a radially externally situated profiled tread, and a belt arranged between the tread and the carcass, which belt has reinforcement member plies and is commonly covered radially on the outside by the belt bandage. The belt bandage may be of single-ply or multi-ply form and covers at least the belt edges.

It is conventional that, for the production of a belt ply, reinforcement members are embedded in rubber by virtue of a set of reinforcement members that lie substantially parallel running in a longitudinal direction through a calender or an extruder in order to be encased with the rubber mixture. These webs are generally cut transversely with respect to their longitudinal direction, such that the parts, individually or joined together, can be used as strengthening member plies in the tire.

The belt, which is composed of two or more belt plies which cross at an angle, ensures the stiffness of the tread in the longitudinal and transverse directions. During travel, this serves for the power transmission, improves the lateral control, and reduces the wear of the tire.

It is known, and nowadays common, for steel cords to be used as reinforcement members in the belt plies of the belt. The steel cords are arranged substantially parallel to and spaced apart from one another in the reinforcement member ply, and are embedded in rubber material in a layer forming manner.

EP 0 849 098 B1 discloses a pneumatic vehicle tire having a first belt ply comprising steel cords of 2×0.35 mm construction, wherein the steel monofilaments have a tensile strength of approximately 3700 N/mm². In the case of such a construction, two steel monofilaments having a diameter of in each case 0.35 mm are twisted to form a cord. Such a first belt ply has advantageous strength characteristics at a comparatively low layer thickness.

However, other characteristics such as handling and rolling resistance must also be taken into consideration in the construction of belt plies.

It is therefore the object of the invention to provide a pneumatic vehicle tyre with low rolling resistance, and simultaneously good handling characteristics.

The object is achieved in that the first belt ply, at a predefined elongation of 1% in the direction of the reinforcement member longitudinal extent, has a stress of 26000 N per dm width to 43000 N per dm width.

It is achieved in accordance with the invention that reinforcement members having an advantageous tensile strength are used, wherein the first belt ply, at a predefined elongation of 1%, has an advantageous stress per dm width of the first belt ply. The background to this is that, on the one hand, a stress of less than 26000 N per dm width has proven to be disadvantageous for the handling characteristics of the tire. On the other hand, a first belt ply having a stress of more than 43000 N per dm width is associated with a comparatively high use of material, which works out disadvantageously in terms of the material costs and the weight and therefore the rolling resistance of the tire.

As a result, a tire which simultaneously has advantageous handling properties at a low rolling resistance is therefore provided.

In the context of the invention, a steel of the reinforcement member class Ultra-Tensile (UT) has a tensile strength of 3185 N/mm² to 3920 N/mm². The “tensile strength” is the tensile stress required to rupture a test subject. It is calculated from the breaking stress determined during the test in relation to the original cross section of the test body. The tensile strength is measured in accordance with ASTM D 2969, ASTM D 4975 and BISTA E6. The force-elongation curve for determining the stress is measured in accordance with ASTM D 2969, ASTM D 4975 and BISTA E6.

In one advantageous embodiment, the diameter of the steel monofilaments D amounts to 0.31 mm to 0.36 mm. The corresponding reinforcement members therefore have a diameter of approximately 0.62 mm to 0.72 mm. This allows the advantageous characteristics of the first ply with regard to use of material and rolling resistance to be improved further.

In the context of the invention, the diameter D is, in formulae, used without units in mm (millimeters). The units in which the calculated variable is defined are stated after the formula.

It has proven to be particularly advantageous when the steel monofilaments have a particularly small diameter D of 0.31 mm to 0.33 mm, particularly preferably of 0.32 mm. A particularly thin first belt ply is provided as a result. With respect to a high tensile strength, it is advantageous when the diameter D amounts to 0.34 mm to 0.36 mm, preferably in that the diameter D is 0.35 mm.

In the case of an embodiment which is particularly advantageous with regard to the conflict of aims between handling and rolling resistance, the first belt ply, at a predefined elongation of 1% in the direction of the reinforcement member longitudinal extent, has a stress of B*(4400−2000*D)*(D/2)²*π/1.6 [N] per dm width, wherein B assumes a value of 80 to 90. A diameter of D=0.32 mm thus yields a stress of 30240 N per dm width to 34020 N per dm width. A diameter of D=0.35 mm thus yields a stress of approximately 35598 N per dm width to 40048 N per dm width.

In one advantageous embodiment, the steel monofilaments have a tensile strength of 3905−2000*D [N/mm²] to 4540−2000*D [N/mm²], where D denotes the diameter of the steel monofilaments. Steel monofilaments of this tensile strength exhibit particularly advantageous strength characteristics at a low diameter. A diameter of D=0.32 mm thus yields a tensile strength of 3265 N/mm² to 3900 N/mm². A diameter of D=0.35 mm thus yields a tensile strength of 3205 N/mm² to 3840 N/mm².

It is advantageous if the steel reinforcement members have a breaking strength of 525 N to 620 N, preferably a breaking strength of 580 N to 590 N. It is also advantageous if a force of 340 N to 400 N, preferably a force of 375 N to 385 N, has to be expended for an elongation of the steel reinforcement members of 1%. The breaking strength and tensile force are measured in accordance with ASTM D 2969, ASTM D 4975 and BISTA E6. Use is particularly preferably made of steel monofilaments with a diameter of D=0.32 mm.

Sufficient strength, in particular with regard to impact loading, with a simultaneously advantageous small layer thickness of the first belt ply are achieved if the first belt ply, under load in the direction of the reinforcement member ply extent, has a layer strength in the region of A*(4400−2000*D)*(D/2)²*π [N] per dm width, wherein A assumes a value of 80 to 90. A diameter of D=0.32 mm thus yields a layer strength of 48384 N per dm width to 54431 N per dm width. A diameter of D=0.35 mm thus yields a layer strength of 56957 N per dm width to 64077 N per dm width.

An advantageous embodiment of the tire is realized if the steel monofilaments in the first belt ply are arranged with 80 epdm to 95 epdm, preferably with 90 epdm. It is particularly advantageous if the diameter of the steel monofilaments amounts to 0.32 mm, and the filament density amounts to 85 epdm to 95 epdm, preferably 90 epdm.

A pneumatic vehicle tire commonly has two, three, four or more belt plies. Each of these plies may be a first belt ply. It may be a radially innermost ply or a radially outermost ply or a middle belt ply.

It is advantageous here if the belt has two first belt plies, wherein the steel monofilaments of one first belt ply are inclined oppositely to the steel monofilaments of the other first belt ply in relation to the tire circumferential direction.

With regard to weight and use of material, it is particularly advantageous if all of the belt plies of the tire are first belt plies. Such a tire exhibits particularly low rolling resistance.

The advantageous tire according to the invention may be a tire for a passenger motor vehicle, a van, a light truck, a utility vehicle or a motorcycle.

Further advantages of the invention are discussed in more detail in conjunction with the following example of a first belt ply that can be used in pneumatic vehicle tires according to the invention:

An exemplary tire of tire size 185/60 R15 has a first belt ply with a belt angle of 28° with respect to the circumferential direction and has, as reinforcement members, steel reinforcement members of 2×0.32 UT construction. The steel monofilaments have a diameter D=0.32 mm and are arranged with a filament density of 90 epdm. Furthermore, the first belt ply, at a predefined elongation of 1% in the direction of the reinforcement member longitudinal extent, has a stress of 30240 N per dm width to 34020 N per dm width. The steel monofilaments have a tensile strength of 3265 N/mm² to 3900 N/mm² auf. The layer has a layer strength of 48384 N per dm width to 54431 N per dm width.

1.-11. (canceled)

12. A pneumatic vehicle tire having two or more belt plies which have reinforcement members crossing one another at an angle, wherein the reinforcement members within each belt ply are arranged substantially parallel to and spaced apart from one another and are embedded in rubber material;
wherein the belt has at least one first belt ply, the reinforcement members of which are formed by steel cords composed of two twisted-together steel monofilaments, wherein the steel falls within the reinforcement member class Ultra-Tensile (UT) with in each case a tensile strength of 3185 N/mm² to 3920 N/mm²; and,
wherein the first belt ply, at a predefined elongation of 1% in the direction of the reinforcement member longitudinal extent, has a stress of 26000 N per dm width to 43000 N per dm width.

13. The pneumatic vehicle tire as claimed in claim 12, wherein the diameter D amounts to 0.31 mm to 0.36 mm.

14. The pneumatic vehicle tire as claimed in claim 13, wherein the diameter D amounts to 0.31 mm to 0.33 mm.

15. The pneumatic vehicle tire as claimed in claim 13, wherein the diameter D amounts to 0.32 mm.

16. The pneumatic vehicle tire as claimed in claim 13, wherein the diameter D amounts to 0.34 mm to 0.36 mm,

17. The pneumatic vehicle tire as claimed in claim 13, wherein the diameter D amounts to 0.35 mm.

18. The pneumatic vehicle tire as claimed in claim 12, wherein the first belt ply, at a predefined elongation of 1% in the direction of the reinforcement member longitudinal extent, has a stress of B*(4400−2000*D)*(D/2)²*π/1.6 [N] per dm width, wherein B assumes a value of 80 to 90.

19. The pneumatic vehicle tire as claimed in claim 12, wherein the steel monofilaments have in each case a tensile strength of 3905−2000*D [N/mm²] to 4540−2000*D [N/mm²], where D denotes the diameter of the steel monofilaments.

20. The pneumatic vehicle tire as claimed in claim 12, wherein the steel monofilaments have a diameter of D=0.32 mm, in that the steel reinforcement members have a breaking strength of 525 N to 620 N, and in that an elongation of a steel reinforcement member of 1% is caused by a force of 340 N to 400 N.

21. The pneumatic vehicle tire as claimed in claim 12, wherein the first belt ply, under load in the direction of the reinforcement member ply extent, has a layer strength in the region of A*(4400−2000*D)*(D/2)²*π [N] per dm width, wherein A assumes a value of 80 to 9.

22. The pneumatic vehicle tire as claimed in claim 12, wherein the steel reinforcement members in the first belt ply are arranged with 80 epdm to 95 epdm, preferably with 90 epdm.

23. The pneumatic vehicle tire as claimed in claim 12, wherein the belt has exactly two belt plies, and in that the two belt plies are first belt plies.

24. The pneumatic vehicle tire as claimed in claim 12, wherein all belt plies of the belt are first belt plies.

25. The pneumatic vehicle tire as claimed in claim 12, wherein it is a tire for a passenger motor vehicle, a van, a light truck, a utility vehicle or a motorcycle.
